(19) United States
(12) Patent Application Publication
(10) Pub. No.: US 2024/0408644 A1
(43) Pub. Date: Dec. 12, 2024

(54) SPRING VIBRATION GENERATION METHOD, APPARATUS, DEVICE, AND STORAGE MEDIUM

(71) Applicant: AAC Acoustic Technologies (Shanghai) Co., Ltd., Shanghai (CN)

(72) Inventors: Yanxin Zhang, Shanghai (CN); Yajun Zheng, Shanghai (CN); Shuhan Yao, Shanghai (CN)

(21) Appl. No.: 18/399,770

(22) Filed: Dec. 29, 2023

Related U.S. Application Data
(63) Continuation of application No. PCT/CN2023/098953, filed on Jun. 7, 2023.

(51) Int. Cl. B06B 1/02

(52) U.S. Cl. CPC B06B 1/0276; B06B 2201/30

(57) ABSTRACT

The present disclosure relates to the technical field of signal processing, and discloses a spring vibration generation method and apparatus, a device, and a storage medium. The method includes: acquiring a preset spring vibration model, and extracting a first characteristic parameter of the spring vibration model; normalizing the first characteristic parameter to generate a spring motion state curve; extracting a second characteristic parameter of the spring motion state curve, and generating a vibration characteristic curve according to the second characteristic parameter based on a preset mapping rule; and extracting a third characteristic parameter of the vibration characteristic curve, and generating a corresponding vibration file according to the third characteristic parameter and outputting the vibration file. In the above manner, according to the present disclosure, an animation effect and a haptic effect of a spring dynamic-effect model can be combined, which increases fun and immersion in the use of electronic products.

### CROSS-REFERENCE TO RELATED APPLICATIONS

This application is a continuation of International Application No. PCT/CN2023/098953, filed on Jun. 7, 2023, which is hereby incorporated by reference in its entirety.

### TECHNICAL FIELD

The present disclosure relates to the technical field of signal processing, and in particular, to a spring vibration generation method, an apparatus, a device, and a storage medium.

### BACKGROUND

With the widespread use of various smart devices and electronic touch screens, haptic feedback is paid more and more attention in the application of electronic products. For example, diversity of application scenes requires rich haptic effects to distinguish different scenes, thereby posing great challenges to the design of haptic effects.

The electronic products in the related art have their own dynamic-effect models and corresponding applications. An elastic model is a common animation effect. However, how to combine an animation effect and a haptic effect of a spring dynamic-effect model to rich the haptic effects, and thereby increase fun and immersion in the use of electronic products, is an urgent problem to be solved.

Therefore, it is necessary to provide a new spring vibration generation method, an apparatus, a device, and a storage medium.

### SUMMARY

The present disclosure provides a spring vibration generation method and apparatus, a device, and a storage medium, which can combine an animation effect and a haptic effect of a spring dynamic-effect model to increase fun and immersion in the use of electronic products.

In order to solve the above technical problem, one technical solution adopted in the present disclosure is as follows. A first aspect of the present disclosure provides a spring vibration generation method. The method includes:
acquiring a preset spring vibration model, and extracting a first characteristic parameter of the spring vibration model;
normalizing the first characteristic parameter to generate a spring motion state curve;
extracting a second characteristic parameter of the spring motion state curve, and generating a vibration characteristic curve according to the second characteristic parameter based on a preset mapping rule; and
extracting a third characteristic parameter of the vibration characteristic curve, and generating a corresponding vibration file according to the third characteristic parameter and outputting the vibration file.

According to an embodiment of the present disclosure, the second characteristic parameter includes an expected vibration frequency, an expected vibration normalized maximum amplitude, an expected vibration duration, and an expected vibration envelope; and the extracting the second characteristic parameter of the spring motion state curve, and generating the vibration characteristic curve according to the second characteristic parameter based on a preset mapping rule includes:
acquiring a first frequency adjacent to a motor and a second frequency away from the motor according to the spring motion state curve;
determining a target vibration period according to the expected vibration frequency, and periodically splicing a vibration signal corresponding to the first frequency and the expected vibration normalized maximum amplitude with a vibration signal corresponding to the second frequency and the expected vibration normalized maximum amplitude to obtain a first vibration signal;
linearly mapping the expected vibration normalized maximum amplitude to a target vibration signal amplitude, and periodically splicing a vibration signal corresponding to the first frequency and the target vibration signal amplitude with a vibration signal corresponding to the second frequency and the target vibration signal amplitude to obtain a second vibration signal;
determining a number of vibration periods according to the expected vibration duration and the target vibration period, and splicing the second vibration signal according to the number of vibration periods to obtain a third vibration signal; and
performing envelope superposition on the third vibration signal according to the expected vibration envelope and the number of vibration periods to obtain a fourth vibration signal as the vibration characteristic curve.

According to an embodiment of the present disclosure, the determining the target vibration period according to the expected vibration frequency, and periodically splicing the vibration signal corresponding to the first frequency and the expected vibration normalized maximum amplitude with a vibration signal corresponding to the second frequency and the expected vibration normalized maximum amplitude to obtain the first vibration signal includes:
determining an expected vibration period according to the expected vibration frequency;
acquiring a preset proportional coefficient, and allocating a first duration of vibration at the first frequency and a second duration of vibration at the second frequency in each half of the expected vibration period according to the preset proportional coefficient and the expected vibration period;
rounding the first duration up to an integer period of the first frequency, rounding the second duration up to an integer period of the second frequency, and determining the target vibration period according to the integer period of the first frequency and the integer period of the second frequency; and
periodically splicing the vibration signal corresponding to the first frequency and the expected vibration normalized maximum amplitude with the vibration signal corresponding to the second frequency and the expected vibration normalized maximum amplitude according to the target vibration period to obtain the first vibration signal.

According to an embodiment of the present disclosure,
the expected vibration period is calculated according to the following formula:

$${T}_{exp} = \frac{1}{{F}_{exp}} ,$$

where Tₑₓₚ denotes the expected vibration period, and Fₑₓₚ denotes the expected vibration frequency;

the first duration is calculated according to the following formula:

$${T}_{1} = \frac{{T}_{exp}}{2} \times α ,$$

where Tₑₓₚ denotes the expected vibration period, T₁ denotes the first duration, and α denotes the preset proportional coefficient; and

the second duration is calculated according to the following formula:

$${T}_{2} = \frac{{T}_{exp}}{2} \times ( 1 - α ) ,$$

where Tₑₓₚ denotes the expected vibration period, T₂ denotes the second duration, and a denotes the preset proportional coefficient.

According to an embodiment of the present disclosure, the determining the target vibration period according to the expected vibration frequency, and periodically splicing the vibration signal corresponding to the first frequency and the expected vibration normalized maximum amplitude with the vibration signal corresponding to the second frequency and the expected vibration normalized maximum amplitude to obtain the first vibration signal includes:
determining the target vibration period according to the expected vibration frequency;
determining signal frequency modulation sensitivity and a carrier frequency according to the first frequency and the second frequency; and
obtaining a first vibration signal within one of the target vibration periods according to the expected vibration frequency, the frequency modulation sensitivity, and the carrier frequency;
wherein the first vibration signal is calculated according to the following formula:

$${S}_{1} = sin ( 2 \times pi \times {f}_{c} \times t + {k}_{f} \times \frac{sin ( 2 \times pi \times {f}_{m} \times t )}{{f}_{m}} ) ,$$

where S₁ denotes the first vibration signal, k_{f} denotes the signal frequency modulation sensitivity, fₘ denotes a baseband signal frequency, configured as the expected vibration frequency, f_{c} denotes the carrier frequency, f_{c}−k_{f} denotes the first frequency, and f_{c}+k_{f} denotes the second frequency.

According to an embodiment of the present disclosure, the first characteristic parameter includes: an elasticity coefficient of a spring, a motion damping coefficient of a motor, mass of the motor, and a motion initial velocity of the motor.

According to an embodiment of the present disclosure, the spring motion state curve is represented according to the following formula: m\ddot{x}+r\dot{x}+kx=0, where m denotes the mass of the motor, r denotes the motion damping coefficient of the motor, k denotes the elasticity coefficient of the spring, \ddot{x} denotes the motion acceleration of the motor, \dot{x} denotes the motion initial velocity of the motor, and x denotes motion displacement of the motor.

In order to solve the above technical problem, another technical solution adopted in the present disclosure is as follows. A second aspect of the present disclosure provides a spring vibration generation apparatus. The apparatus includes:
an acquisition module configured to acquire a preset spring vibration model, and extract a first characteristic parameter of the spring vibration model;
a normalization module configured to normalize the first characteristic parameter to generate a spring motion state curve;
a mapping module configured to extract a second characteristic parameter of the spring motion state curve, and generate a vibration characteristic curve according to the second characteristic parameter based on a preset mapping rule; and
a generation module configured to extract a third characteristic parameter of the vibration characteristic curve, generate a corresponding vibration file according to the third characteristic parameter, and output the vibration file.

In order to solve the above technical problem, yet another technical solution adopted in the present disclosure is as follows. A third aspect of the present disclosure provides a computer device. The computer device includes: a memory, a processor, and a computer program stored in the memory and executable by the processor, wherein the processor, when executing the computer program, implements the spring vibration generation method.

In order to solve the above technical problem, yet another technical solution adopted in the present disclosure is as follows. A fourth aspect of the present disclosure provides a computer storage medium on which a computer program is stored. When the computer program is executed by a processor, the above spring vibration generation method is implemented.

### BRIEF DESCRIPTION OF DRAWINGS

FIG. 1 is a schematic flowchart of a spring vibration generation method according to an embodiment of the present disclosure;

FIG. 2 is a schematic flowchart of a spring vibration generation method according to another embodiment of the present disclosure;

FIG. 3 is a schematic flowchart of a spring vibration generation method according to another embodiment of the present disclosure;

FIG. 4 is a schematic flowchart of a spring vibration generation method according to another embodiment of the present disclosure;

FIG. 5 is a structural schematic diagram of a spring vibration generation apparatus according to an embodiment of the present disclosure;

FIG. 6 is a structural schematic diagram of a computer device according to an embodiment of the present disclosure; and

FIG. 7 is a structural schematic diagram of a computer storage medium according to an embodiment of the present disclosure.

### DESCRIPTION OF EMBODIMENTS

The present disclosure is further described below with reference to the accompanying drawings and embodiments.

Spring vibration in the present disclosure may be applied to various smart devices and electronic touch screens. Taking a mobile phone as an example, the mobile phone may include at least a touch screen component, a processor, a driver chip, and a motor. The touch screen component is configured to display and receive coordinate information and pressure information of touch operations. The processor is connected to the touch screen component and the driver chip, and is configured to receive the coordinate information and the pressure information and to generate a drive signal according to the coordinate information and the pressure information and transmit the drive signal to the driver chip. The driver chip is connected to the motor, and is configured to drive the motor to vibrate based on the drive signal to generate vibration.

In an application scene in which dynamic effects of a spring vibration model may be used in startup animation, download animation, pull-down refresh, and the like of the mobile phone, animation effects and touch of a spring dynamic-effect model are combined to create a corresponding haptic effect, an elastic effect is achieved through the spring vibration model, and an elastic effect of a spring is highly restored, which can increase fun and immersion in the use of the mobile phone. In an embodiment, parameter mapping and binding are performed on a preset dynamic-effect model (such as the spring vibration model) and a haptic effect in an operating system of the mobile phone or an application (APP) of the mobile phone, to generate touch with a spring vibration effect, which may be applied to scenes such as user interface (UI) interactive control, animation, dynamic wallpaper, and dynamic theme scenes.

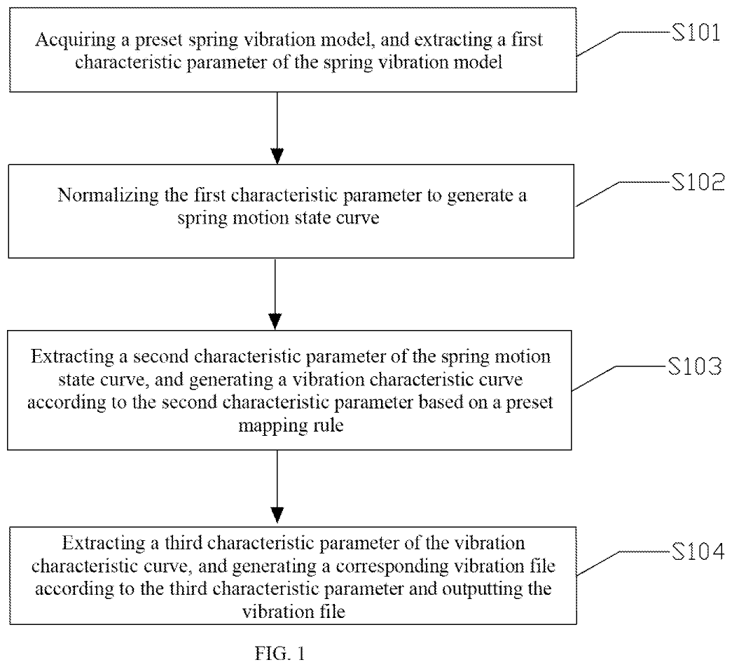

FIG. 1 is a schematic flowchart of a spring vibration generation method according to another embodiment of the present disclosure. It is to be noted that, in the case of results identical in essence, the method of the present disclosure is not limited to the process sequence shown in FIG. 1. As shown in FIG. 1, the method includes the following steps.

In step S101, a preset spring vibration model is acquired, and a first characteristic parameter of the spring vibration model is extracted.

In step S101, the spring vibration model may achieve an elastic dynamic effect and can highly restore an elastic effect of a spring. The spring vibration model in this embodiment is a preset model, which may be preset in an application device. In an embodiment, a spring single-vibrator model is selected, and a first characteristic parameter of the spring single-vibrator model is extracted. The first characteristic parameter includes, but is not limited to, an elasticity coefficient of a spring, a motion damping coefficient of a motor, mass of the motor, and a motion initial velocity of the motor.

In step S102, the first characteristic parameter is normalized to generate a spring motion state curve.

In step S102, based on the spring single-vibrator model, the elasticity coefficient of the spring, the motion damping coefficient of the motor, the mass of the motor, and the motion initial velocity of the motor are normalized respectively, and an appropriate normalization coefficient is preset in consideration of an actual frequency range of a reality spring under free vibration and an actual capacity of the motor, causing the spring motion state curve outputted by the spring single-vibrator model to be adjacent to the reality spring. In an embodiment, the spring motion state curve is represented according to the following formula:

m\ddot{x}+r\dot{x}+kx=0,

where m denotes the mass of the motor, r denotes the motion damping coefficient of the motor, k denotes the elasticity coefficient of the spring, \ddot{x} denotes the motion acceleration of the motor, \dot{x} denotes the motion initial velocity of the motor, and x denotes motion displacement of the motor.

In step S103, a second characteristic parameter of the spring motion state curve is extracted, and a vibration characteristic curve is generated according to the second characteristic parameter based on a preset mapping rule.

In step S103, a free oscillation frequency of the reality spring is generally very low, such as below 40 Hz. Due to limitations in the capacity of the motor, vibration caused by a simple ultra-low-frequency signal may be completely covered by strong distortion, so that a low-frequency component cannot be experienced at all, reducing the haptic effect. In this embodiment of the present disclosure, frequency modulation may be performed in the following manner, to realize ultra-low-frequency vibration of the spring.

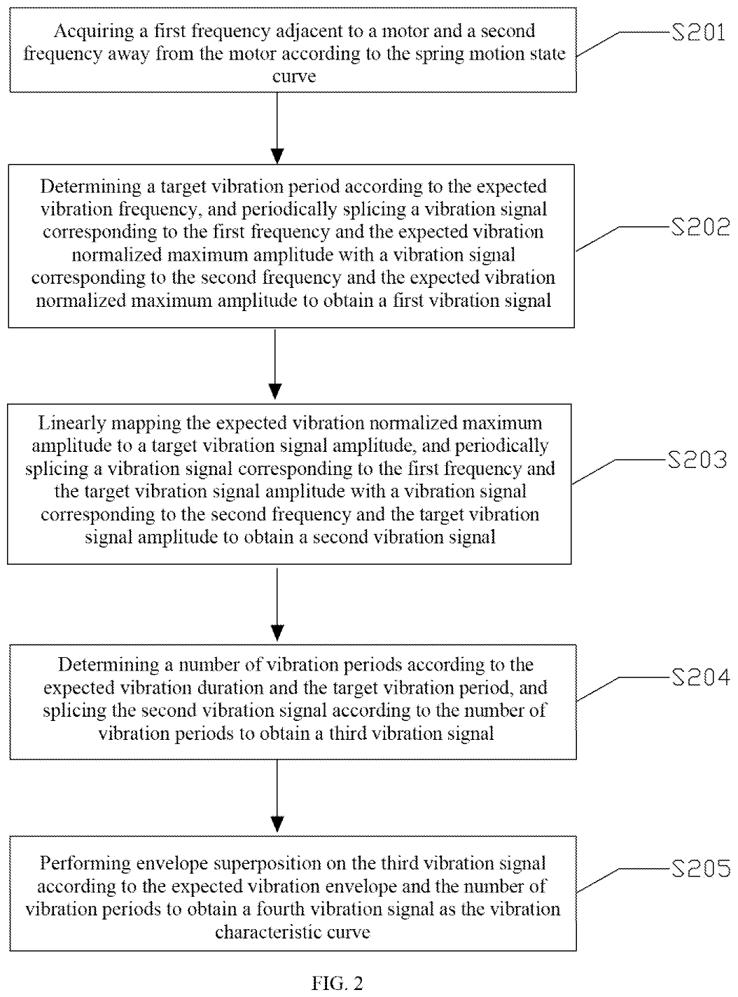

In an embodiment, the second characteristic parameter includes, but is not limited to, an expected vibration frequency, an expected vibration normalized maximum amplitude, an expected vibration duration, and an expected vibration envelope. Referring to FIG. 2, step S103 may further include the following steps.

In step S201, a first frequency adjacent to a motor and a second frequency away from the motor are acquired according to the spring motion state curve.

In step S201, the first frequency is adjacent to a resonant frequency of the motor, and the second frequency is away from the resonant frequency of the motor. The resonant frequency of the motor is determined by the spring motion state curve.

In step S202, a target vibration period is determined according to the expected vibration frequency, and a vibration signal corresponding to the first frequency and the expected vibration normalized maximum amplitude is periodically spliced with a vibration signal corresponding to the second frequency and the expected vibration normalized maximum amplitude to obtain a first vibration signal.

In step S202, the target vibration period may be an expected vibration period or an actual vibration period. A vibration duration of the first vibration signal is a target vibration period. In this embodiment of the present disclosure, the vibration signal corresponding to the first frequency and the expected vibration normalized maximum amplitude is periodically spliced with the vibration signal corresponding to the second frequency and the expected vibration normalized maximum amplitude to simulate and display the ultra-low frequency vibration of the spring.

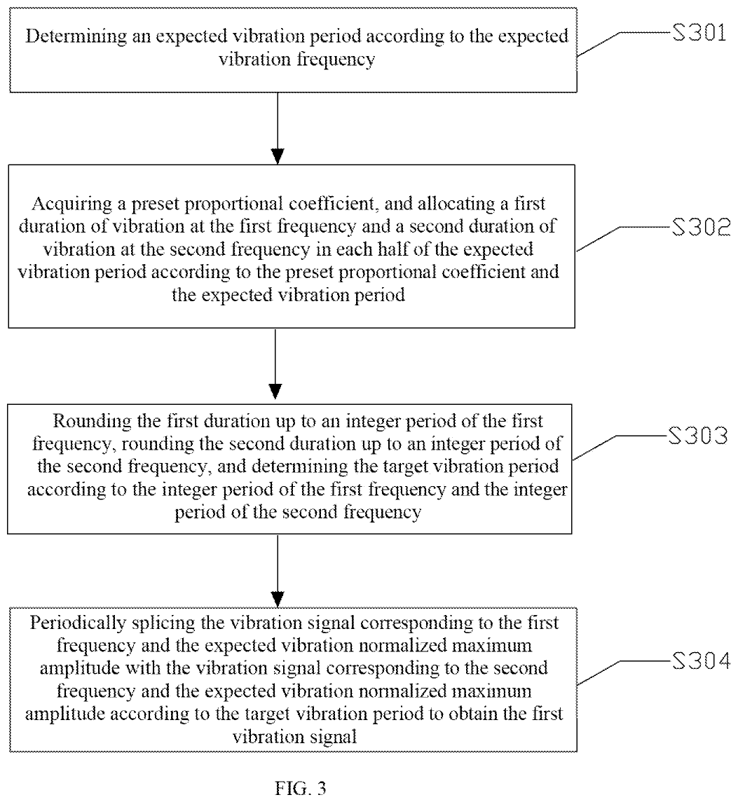

In an embodiment, referring to FIG. 3, step S202 further includes the following steps.

In step S301, an expected vibration period is determined according to the expected vibration frequency.

In this embodiment, the expected vibration period is calculated according to the following formula:

$${T}_{exp} = \frac{1}{{F}_{exp}} ,$$

where Tₑₓₚ denotes the expected vibration period, and Fₑₓₚ denotes the expected vibration frequency.

In step S302, a preset proportional coefficient is acquired, and a first duration of vibration at the first frequency and a second duration of vibration at the second frequency in each half of the expected vibration period are allocated according to the preset proportional coefficient and the expected vibration period.

In this embodiment, a sum of the first duration and the second duration is half the expected vibration period. In each half of the expected vibration period, a former part of the duration vibrates according to the first frequency, and a latter part of the duration vibrates according to the second frequency. That is, in each half of the expected vibration period, vibration is performed at the first frequency for the first duration, and vibration is performed at the second frequency for the second duration. The proportional coefficient in this embodiment may be a default value, or set by a user according to test experiments. Exemplarily, the first duration is calculated according to the following formula:

$${T}_{1} = \frac{{T}_{exp}}{2} \times α ,$$

where Tₑₓₚ denotes the expected vibration period, T₁ denotes the first duration, and α denotes the preset proportional coefficient. The second duration is calculated according to the following formula:

$${T}_{2} = \frac{{T}_{exp}}{2} \times ( 1 - α ) ,$$

where Tₑₓₚ denotes the expected vibration period, T₂ denotes the second duration, and a denotes the preset proportional coefficient.

In step S303, the first duration is rounded up to an integer period of the first frequency, the second duration is rounded up to an integer period of the second frequency, and the target vibration period is determined according to the integer period of the first frequency and the integer period of the second frequency.

In this embodiment, the first duration and the second duration are respectively rounded up to an integer number of periods, a vibration signal at the first frequency and a vibration signal at the second frequency are directly spliced without transition, and a complete actual vibration period of the spring is obtained. That is, the target vibration period is a sum of the integer period of the first frequency and the integer period of the second frequency.

In step S304, the vibration signal corresponding to the first frequency and the expected vibration normalized maximum amplitude is periodically spliced with the vibration signal corresponding to the second frequency and the expected vibration normalized maximum amplitude according to the target vibration period to obtain the first vibration signal.

In this embodiment, the first vibration signal is formed by splicing two vibration signals at different frequencies and having an amplitude equal to the expected vibration normalized maximum amplitude, and the duration is one target vibration period.

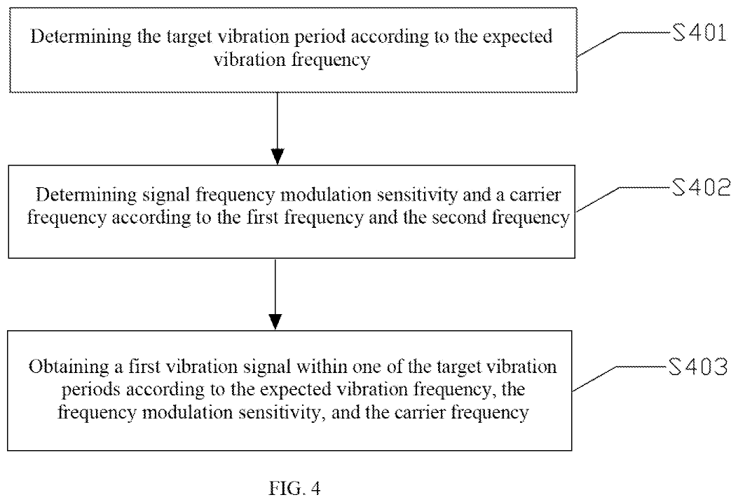

In an embodiment, referring to FIG. 4, step S202 further includes the following steps.

In step S401, the target vibration period is determined according to the expected vibration frequency.

In this embodiment, the target vibration period is an expected vibration period. The expected vibration period is calculated according to the following formula:

$${T}_{exp} = \frac{1}{{F}_{exp}} ,$$

where Tₑₓₚ denotes the expected vibration period, and Fₑₓₚ denotes the expected vibration frequency.

In step S402, signal frequency modulation sensitivity and a carrier frequency are determined according to the first frequency and the second frequency.

In this embodiment, a difference between a carrier frequency signal and frequency modulation sensitivity is the first frequency, and a sum of the carrier frequency signal and the frequency modulation sensitivity is the second frequency. Based on the above relationship, the signal frequency modulation sensitivity and the carrier frequency may be calculated.

In step S403, a first vibration signal within one of the target vibration periods is obtained according to the expected vibration frequency, the frequency modulation sensitivity, and the carrier frequency.

The first vibration signal is calculated according to the following formula:

$${S}_{1} = sin ( 2 \times pi \times {f}_{c} \times t + {k}_{f} \times \frac{sin ( 2 \times pi \times {f}_{m} \times t )}{{f}_{m}} ) ,$$

where S₁ denotes the first vibration signal, k_{f} denotes the signal frequency modulation sensitivity, fₘ denotes a baseband signal frequency, configured as the expected vibration frequency, f_{c} denotes the carrier frequency, f_{c}−k_{f} denotes the first frequency, and f_{c}+k_{f} denotes the second frequency.

In step S203, the expected vibration normalized maximum amplitude is linearly mapped to a target vibration signal amplitude, and a vibration signal corresponding to the first frequency and the target vibration signal amplitude is periodically spliced with a vibration signal corresponding to the second frequency and the target vibration signal amplitude to obtain a second vibration signal.

In step S203, according to an actual capacity of the motor, the expected vibration normalized maximum amplitude is linearly mapped, the expected vibration normalized maximum amplitude is mapped to the target vibration signal amplitude, the second vibration signal is formed by splicing two vibration signals at different frequencies and having an amplitude equal to the target vibration signal amplitude, and the duration is one target vibration period.

In step S204, a number of vibration periods is determined according to the expected vibration duration and the target vibration period, and the second vibration signal is spliced according to the number of vibration periods to obtain a third vibration signal.

In step S204, the number of vibration periods may be calculated according to the following formula:

$$N = ceil ( \frac{{Dur}_{exp}}{{T}_{act}} ) ,$$

where ceil denotes rounding up, Durₑₓₚ denotes the expected vibration duration, T_{act} denotes the target vibration period, and N denotes the number of vibration periods. The second vibration signal is spliced N times to obtain the third vibration signal.

In step S205, envelope superposition is performed on the third vibration signal according to the expected vibration envelope and the number of vibration periods to obtain a fourth vibration signal, namely, the vibration characteristic curve.

In step S205, an expected vibration envelope duration of the spring is scaled to be equal to the vibration duration of the third vibration signal, and envelope superposition is performed on the third vibration signal to obtain a fourth vibration signal. In some embodiments, an envelope may be obtained from a model, or a descending envelope curve may be customized. The fourth vibration signal is a vibration signal whose intensity decreases according to a certain rule, whose frequency suddenly changes periodically, and whose duration is a product of the target vibration period and the number of vibration periods, which is an actual vibration signal, namely, the vibration characteristic curve.

In step S104, a third characteristic parameter of the vibration characteristic curve is extracted, and a corresponding vibration file is generated according to the third characteristic parameter and is outputted.

In step S104, a characteristic parameter of the vibration file is extracted according to the above vibration characteristic curve, is written into a final readable vibration format file, and is outputted.

According to the spring vibration generation method in an embodiment of the present disclosure, an animation effect and a haptic effect of the spring dynamic-effect model can be combined by acquiring a preset spring vibration model, and extracting a first characteristic parameter of the spring vibration model; normalizing the first characteristic parameter to generate a spring motion state curve; extracting a second characteristic parameter of the spring motion state curve, and generating a vibration characteristic curve according to the second characteristic parameter based on a preset mapping rule; and extracting a third characteristic parameter of the vibration characteristic curve, and generating a corresponding vibration file according to the third characteristic parameter and outputting the vibration file, thereby increasing fun and immersion in the use of electronic products.

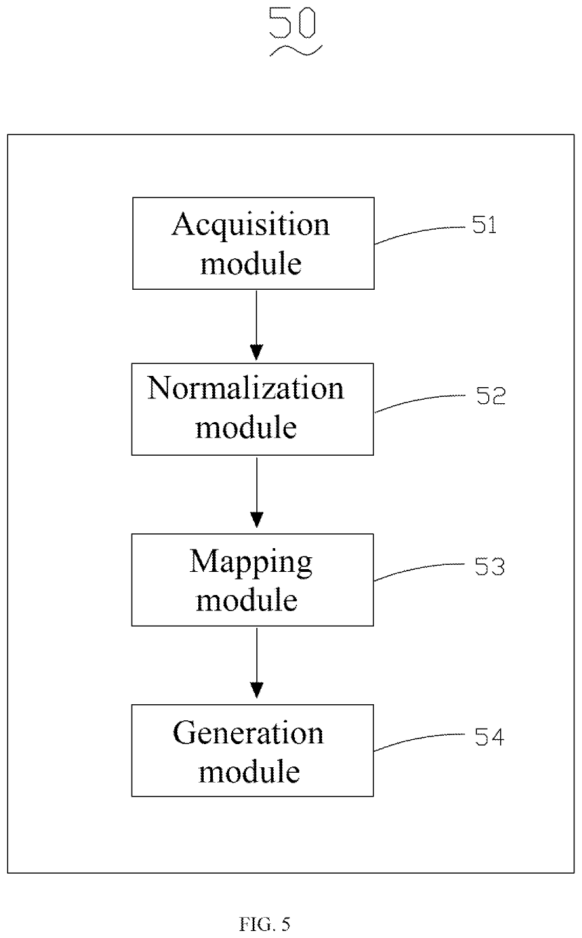

FIG. 5 is a structural schematic diagram of a spring vibration generation apparatus according to an embodiment of the present disclosure. As shown in FIG. 5, the apparatus 50 includes an acquisition module 51, a normalization module 52, a mapping module 53, and a generation module 54.

The acquisition module 51 is configured to acquire a preset spring vibration model, and extract a first characteristic parameter of the spring vibration model.

The normalization module 52 is configured to normalize the first characteristic parameter to generate a spring motion state curve.

The mapping module 53 is configured to extract a second characteristic parameter of the spring motion state curve, and generate a vibration characteristic curve according to the second characteristic parameter based on a preset mapping rule.

The generation module 54 is configured to extract a third characteristic parameter of the vibration characteristic curve, generate a corresponding vibration file according to the third characteristic parameter, and output the vibration file.

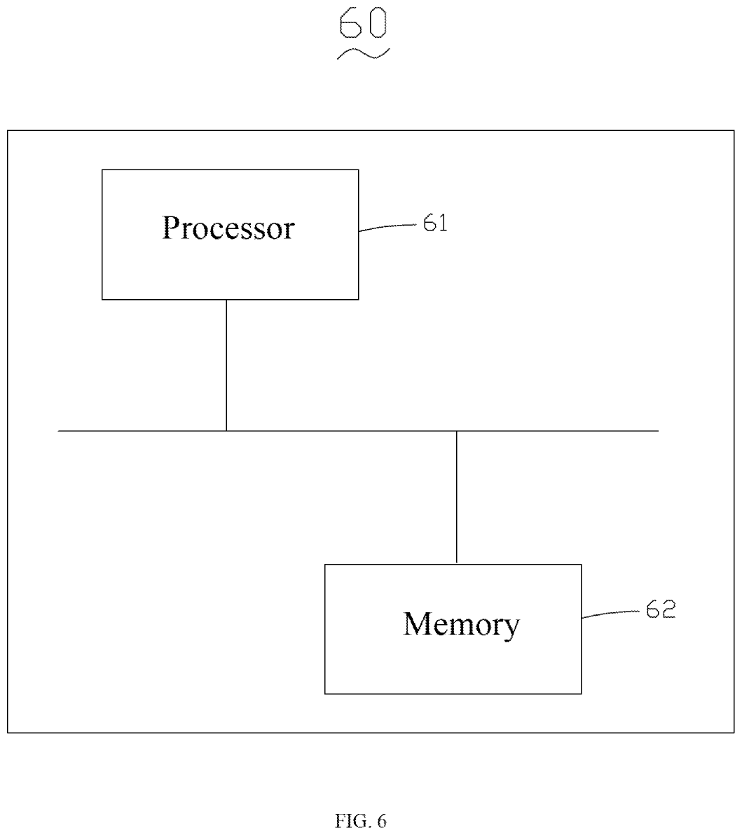

Referring to FIG. 6, FIG. 6 is a structural schematic diagram of a computer device according to an embodiment of the present disclosure. As shown in FIG. 6, the computer device 60 includes a processor 61 and a memory 62 coupled to the processor 61.

The memory 62 stores program instructions used to implement the spring vibration generation method described in any one of the above embodiments.

The processor 61 is configured to execute the program instructions stored in the memory 62 to generate spring vibration.

The processor 61 may also be called a central processing unit (CPU). The processor 61 may be an integrated circuit chip and has a signal processing capability. The processor 61 may alternatively be a general-purpose processor, a digital signal processor (DSP), an application-specific integrated circuit (ASIC), a field programmable gate array (FPGA) or another programmable logic device, a discrete gate, a transistor logic device, or a discrete hardware component. The general-purpose processor may be a microprocessor, or the processor may be any conventional processor or the like.

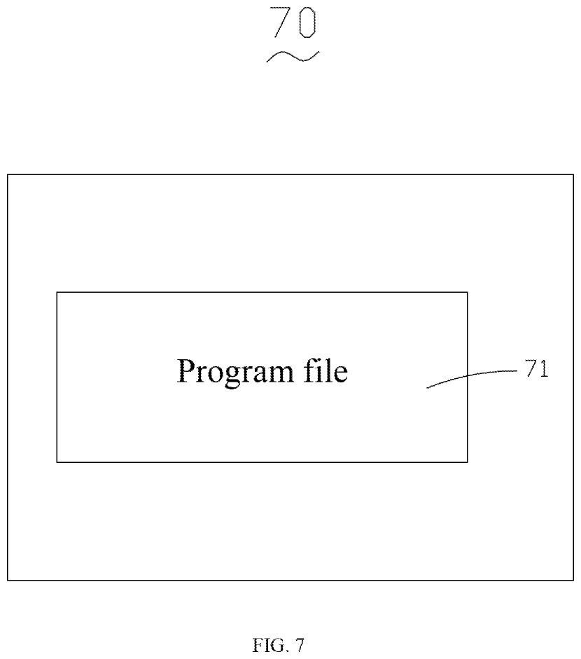

Referring to FIG. 7, FIG. 7 is a structural schematic diagram of a computer storage medium according to an embodiment of the present disclosure. The computer storage medium according to this embodiment of the present disclosure stores a program file 71 that can implement all the above methods. The program file 71 may be stored in the above computer storage medium in a form of a software product, including several instructions for causing a computer device (which may be a personal computer, a server, a network device, or the like) or a processor to perform all or some of the steps of the methods described in the embodiments of the present disclosure. The foregoing computer storage medium includes: any medium that can store program code, such as a USB flash drive, a removable hard disk, a read-only memory (ROM), a random access memory (RAM), a magnetic disk, or an optical disc, or a terminal device such as a computer, a server, a mobile phone, or a tablet computer.

In the embodiments provided in the present disclosure, it should be understood that the apparatus and method disclosed may be implemented in other manners. For example, the apparatus embodiments described above are only illustrative. For example, the division of the units is merely logical function division, and there may be other division manners in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between apparatuses or units may be implemented in an electric form, a mechanical form, or other forms.

In addition, the functional units in the embodiments of the present disclosure may be integrated into one processing unit, or each of the units may exist alone physically, or two or more units are integrated into one unit. The integrated unit may be implemented in a form of hardware or in a form of a software functional unit.

The above are merely embodiments of the present disclosure. It should be noted here that those of ordinary skill in the art can make improvements without departing from the creative concept of the present disclosure, but these all fall within the protection scope of the present disclosure.

What is claimed is:

1. A spring vibration generation method, comprising:
acquiring a preset spring vibration model, and extracting a first characteristic parameter of the spring vibration model;
normalizing the first characteristic parameter to generate a spring motion state curve;
extracting a second characteristic parameter of the spring motion state curve, and generating a vibration characteristic curve according to the second characteristic parameter based on a preset mapping rule; and
extracting a third characteristic parameter of the vibration characteristic curve, and generating a corresponding vibration file according to the third characteristic parameter and outputting the vibration file.

2. The spring vibration generation method as described in claim 1, wherein the second characteristic parameter comprises an expected vibration frequency, an expected vibration normalized maximum amplitude, an expected vibration duration, and an expected vibration envelope; and
wherein the extracting the second characteristic parameter of the spring motion state curve, and generating the vibration characteristic curve according to the second characteristic parameter based on a preset mapping rule, comprises:
acquiring a first frequency adjacent to a motor and a second frequency away from the motor according to the spring motion state curve;
determining a target vibration period according to the expected vibration frequency, and periodically splicing a vibration signal corresponding to the first frequency and the expected vibration normalized maximum amplitude with a vibration signal corresponding to the second frequency and the expected vibration normalized maximum amplitude to obtain a first vibration signal;
linearly mapping the expected vibration normalized maximum amplitude to a target vibration signal amplitude, and periodically splicing a vibration signal corresponding to the first frequency and the target vibration signal amplitude with a vibration signal corresponding to the second frequency and the target vibration signal amplitude to obtain a second vibration signal;
determining a number of vibration periods according to the expected vibration duration and the target vibration period, and splicing the second vibration signal according to the number of vibration periods to obtain a third vibration signal; and
performing envelope superposition on the third vibration signal according to the expected vibration envelope and the number of vibration periods to obtain a fourth vibration signal as the vibration characteristic curve.

3. The spring vibration generation method as described in claim 2, wherein the determining the target vibration period according to the expected vibration frequency, and periodically splicing the vibration signal corresponding to the first frequency and the expected vibration normalized maximum amplitude with a vibration signal corresponding to the second frequency and the expected vibration normalized maximum amplitude to obtain the first vibration signal comprises:
determining an expected vibration period according to the expected vibration frequency;
acquiring a preset proportional coefficient, and allocating a first duration of vibration at the first frequency and a second duration of vibration at the second frequency in each half of the expected vibration period according to the preset proportional coefficient and the expected vibration period;
rounding the first duration up to an integer period of the first frequency, rounding the second duration up to an integer period of the second frequency, and determining the target vibration period according to the integer period of the first frequency and the integer period of the second frequency; and
periodically splicing the vibration signal corresponding to the first frequency and the expected vibration normalized maximum amplitude with the vibration signal corresponding to the second frequency and the expected vibration normalized maximum amplitude according to the target vibration period to obtain the first vibration signal.

4. The spring vibration generation method as described in claim 3, wherein
the expected vibration period is calculated according to the following formula:
$${T}_{exp} = \frac{1}{{F}_{exp}} ,$$
where Tₑₓₚ denotes the expected vibration period, and Fₑₓₚ denotes the expected vibration frequency;
the first duration is calculated according to the following formula:
$${T}_{1} = \frac{{T}_{exp}}{2} \times α ,$$
where Tₑₓₚ denotes the expected vibration period, T₁ denotes the first duration, and a denotes the preset proportional coefficient; and
the second duration is calculated according to the following formula:
$${T}_{2} = \frac{{T}_{exp}}{2} \times ( 1 - α ) ,$$
where Tₑₓₚ denotes the expected vibration period, T₂ denotes the second duration, and α denotes the preset proportional coefficient.

5. The spring vibration generation method as described in claim 2, wherein the determining the target vibration period according to the expected vibration frequency, and periodically splicing the vibration signal corresponding to the first frequency and the expected vibration normalized maximum amplitude with the vibration signal corresponding to the second frequency and the expected vibration normalized maximum amplitude to obtain the first vibration signal comprises:
determining the target vibration period according to the expected vibration frequency;
determining signal frequency modulation sensitivity and a carrier frequency according to the first frequency and the second frequency; and
obtaining a first vibration signal within one of the target vibration periods according to the expected vibration frequency, the frequency modulation sensitivity, and the carrier frequency;
wherein the first vibration signal is calculated according to the following formula:
$${S}_{1} = sin ( 2 \times pi \times {f}_{c} \times t + {k}_{f} \times \frac{sin ( 2 \times pi \times {f}_{m} \times t )}{{f}_{m}} ) ,$$
where S₁ denotes the first vibration signal, k_{f} denotes the signal frequency modulation sensitivity, fₘ denotes a baseband signal frequency, configured as the expected vibration frequency, f_{c} denotes the carrier frequency, f_{c}−k_{f} denotes the first frequency, and f_{c}+k_{f} denotes the second frequency.

6. The spring vibration generation method as described in claim 1, wherein the first characteristic parameter comprises: an elasticity coefficient of a spring, a motion damping coefficient of a motor, a mass of the motor, and a motion initial velocity of the motor.

7. The spring vibration generation method as described in claim 6, wherein the spring motion state curve is represented according to the following formula:
m\ddot{x}+r\dot{x}+kx=0,
where m denotes the mass of the motor, r denotes the motion damping coefficient of the motor, k denotes the elasticity coefficient of the spring, \ddot{x} denotes the motion acceleration of the motor, \dot{x} denotes the motion initial velocity of the motor, and x denotes motion displacement of the motor.

8. A spring vibration generation apparatus, comprising:
an acquisition module configured to acquire a preset spring vibration model, and extract a first characteristic parameter of the spring vibration model;
a normalization module configured to normalize the first characteristic parameter to generate a spring motion state curve;
a mapping module configured to extract a second characteristic parameter of the spring motion state curve, and generate a vibration characteristic curve according to the second characteristic parameter based on a preset mapping rule; and
a generation module configured to extract a third characteristic parameter of the vibration characteristic curve, generate a corresponding vibration file according to the third characteristic parameter, and output the vibration file.

9. A computer storage medium, storing a computer program thereon, wherein the spring vibration generation method as described in claim 1 is implemented when the computer program is executed by a processor.
